(19) United States
(12) Patent Application Publication
(10) Pub. No.: US 2004/0088943 A1
(43) Pub. Date: May 13, 2004

(54) Plug connector for hollow sections

(76) Inventor: Max Kronenberg, Solingen (DE)

Correspondence Address: McGlew & Tuttle, Scarborough Station, Scarborough, NY, 10510-0827, US

(21) Appl. No.: 10/311,834

(22) PCT Filed: Sep. 12, 2001
(86) PCT No.: PCT/EP01/10505

(30) Foreign Application Priority Data
Sep. 13, 2000 (DE) 20015913.5

(51) Int. Cl. E06B 3/70; E04C 2/38

(52) U.S. Cl. 52/656.9; 52/456

(57) ABSTRACT

The invention relates to a plug connector (1) for hollow sections (24) of spacer frames for insulating glass panes. Said plug connector comprises a plurality of lateral retainer elements (12, 13, 14) on the side wall, said retainer elements being arranged one after the other in the plug-in direction (9) of the hollow sections (24). At least some of said retainer elements are offset at a mutual distance (16, 17) transversely in relation to the plug-in direction. The retainer elements (12, 13, 14) are thus preferably arranged at various levels (h12, h13, h14), thereby engaging at various points on the hollow section (24).

The present invention pertains to a plug-in connector for hollow sections with the features described in the preamble of the principal claim.

Such a plug-in connector has been known from EP-A 0 283 689. It is designed for hollow sections of spacer frames of insulating glass panes and has at its two side walls a plurality of retaining elements, which are arranged one after another in the direction in which the hollow sections are plugged in.

The object of the present invention is to show a plug-in connector with improved retaining elements.

This object is accomplished by the present invention with the features described in the principal claim.

The offset arrangement of and the mutual distance between the retaining elements at right angles to the direction of plugging-in have the advantage that the retaining elements can act at different positions on the adjacent side wall. This improves the retention of the plug-in connector in the hollow section, because the different retaining elements exert their retaining function in a greater number and more uniformly.

All retaining elements are arranged in one row one after another in the direction of plugging-in in the state of the art, as a result of which they have different retaining capacities due to tolerances. This is especially true if the retaining elements dig into the side wall of the hollow section during plugging in and form a track or groove-shaped depression in the side wall during the plugging-in operation. Mainly the retaining element that is arranged laterally the farthest and that also determines the depth of dug-in acts in this common track. The other retaining elements, which are arranged less far out, may possibly have less or no contact with this track and a correspondingly reduced retaining function. This problem is eliminated with the offset arrangement of and the mutual distance between the retaining elements at right angles to the direction of plugging-in.

The offset arrangement may be present for all retaining elements or for only some of the retaining elements. It is present above all at the side walls of the body sections, because these retaining elements act together on a side wall of a hollow section. The retaining elements at the other side walls or body sections act on other hollow section walls.

The offset arrangement of the retaining elements is preferably designed as a vertical offset. This is especially advantageous for the usual plug-in connectors with an essentially rectangular cross-sectional contour. Furthermore, the design according to the present invention also offers advantages for the connection of bar sections and the desiccant flow at the connection point. The improved seating and hold of the plug-in connector have a favorable effect in the hollow sections for this.

The vertical offset is preferably is constant and of uniform size. The retaining element with the greatest height may be optionally located in the area of the middle or the outer front side of the plug-in connector. The retaining elements following it are then arranged lower in a continuous series. At least the retaining element with the greatest height may also project on the edge side in height over the side wall of the plug-in connector and ensure an additional bracing of the plug-in connector in the hollow section or the bar section.

The plug-in connector may otherwise have various designs as desired. It may be a straight connector or a corner connector or the like for spacer frames of insulating glass panes. Furthermore, the plug-in connector may be a straight connector or a cross connector for bar sections. These are preferred fields of use. In addition, the plug-in connectors may also be used for any other purpose and other hollow sections. The plug-in connectors may also have any desired cross-sectional shape and be designed as components that are hollow or massive in at least some areas.

Special advantages arise for plug-in connectors that are designed as punched and bent parts made of metal. The offset retaining elements can be manufactured especially well and effectively in this case. Otherwise, the plug-in connectors may also consist of other materials, e.g., plastic, composite or the like.

Additional advantageous embodiments of the present invention are described in the subclaims.

The present invention is schematically described in the drawings as an example. Specifically,

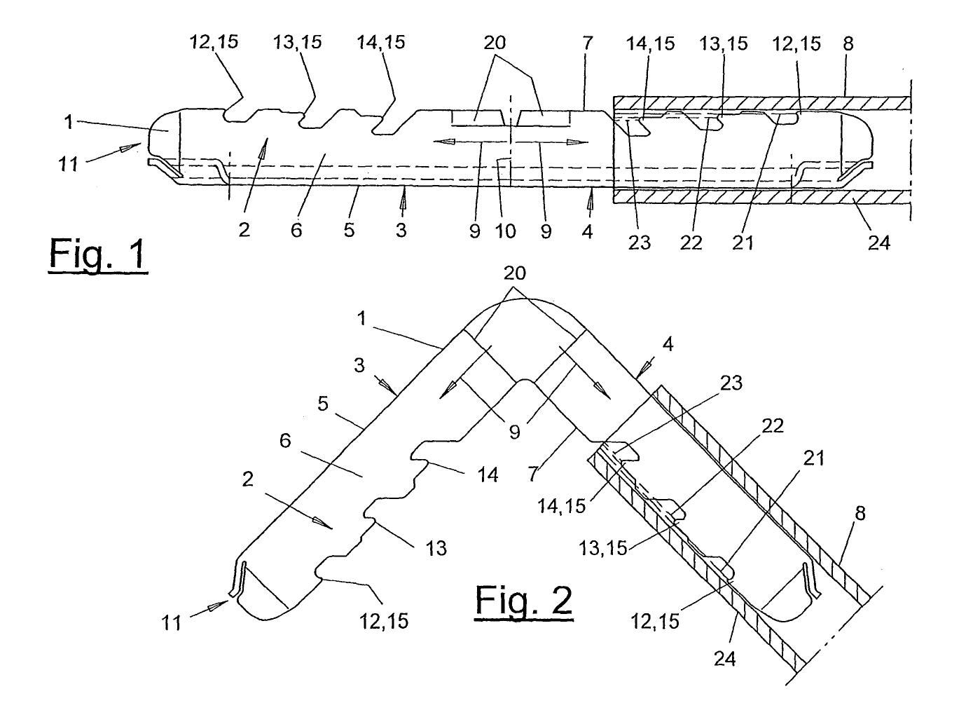

FIG. 1 shows a side view of a straight plug-in connector with a cut-away view of a hollow section,

FIG. 2 shows a variant of the plug-in connector in FIG. 1 in the form of a corner angle,

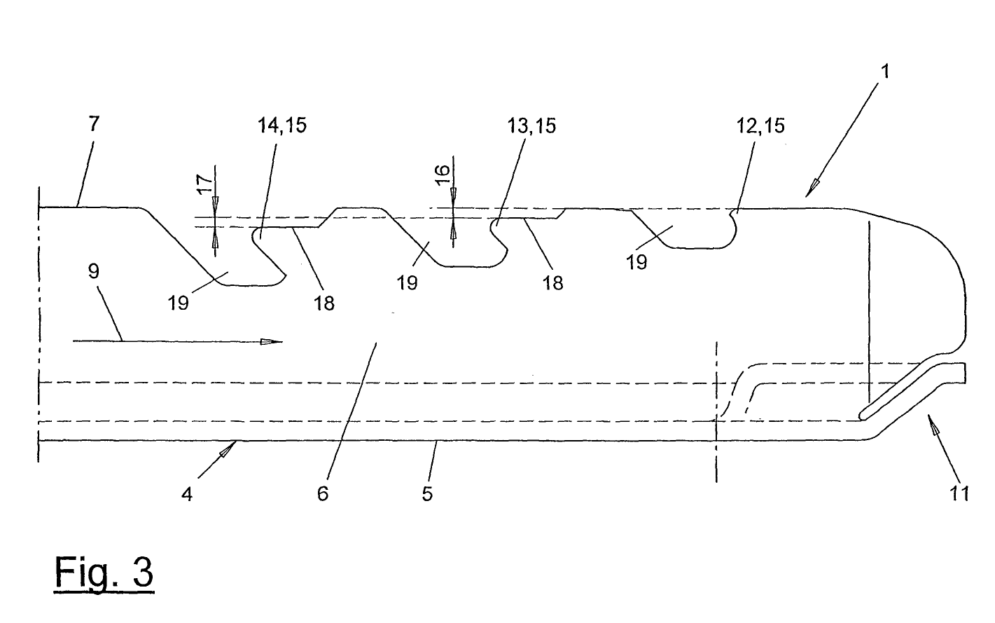

FIG. 3 shows an enlarged side view of the retaining elements at a plug-in connector,

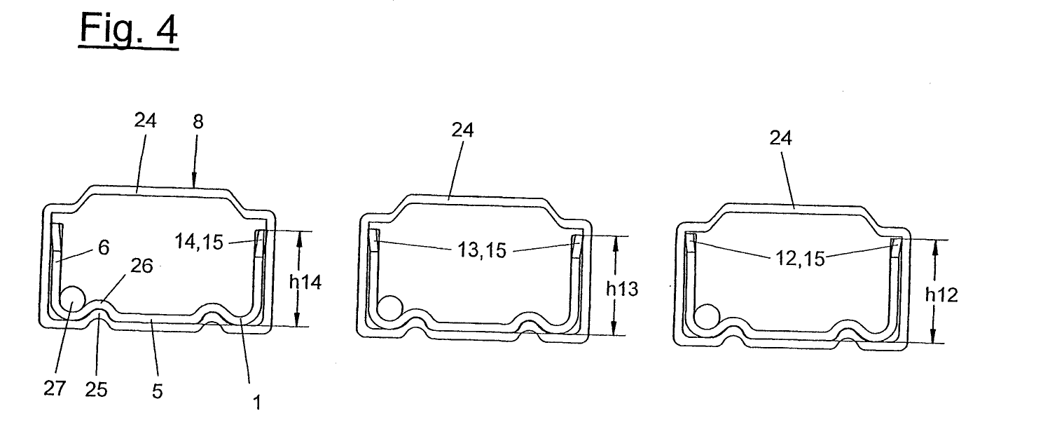

FIG. 4 shows a schematic front view of the plug-in connector in the hollow section with retaining elements of different heights,

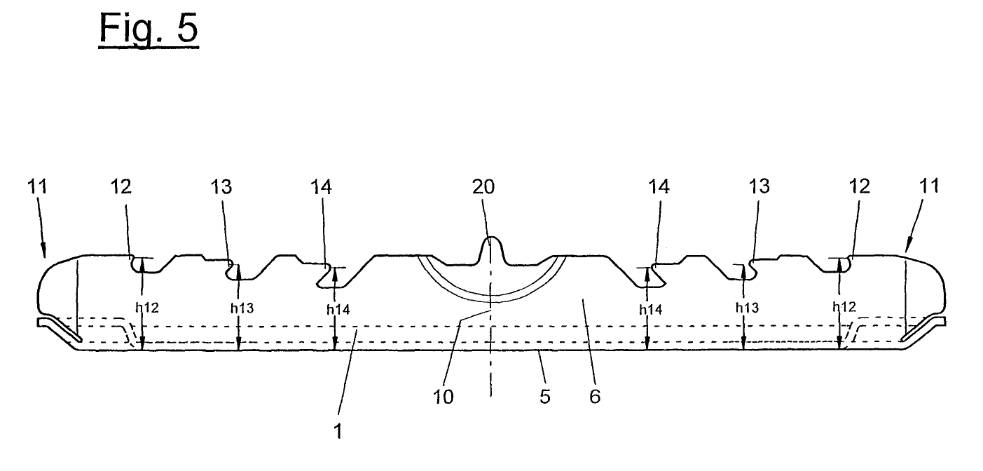

FIG. 5 shows a side view of a variant of the plug-in connector in FIG. 1,

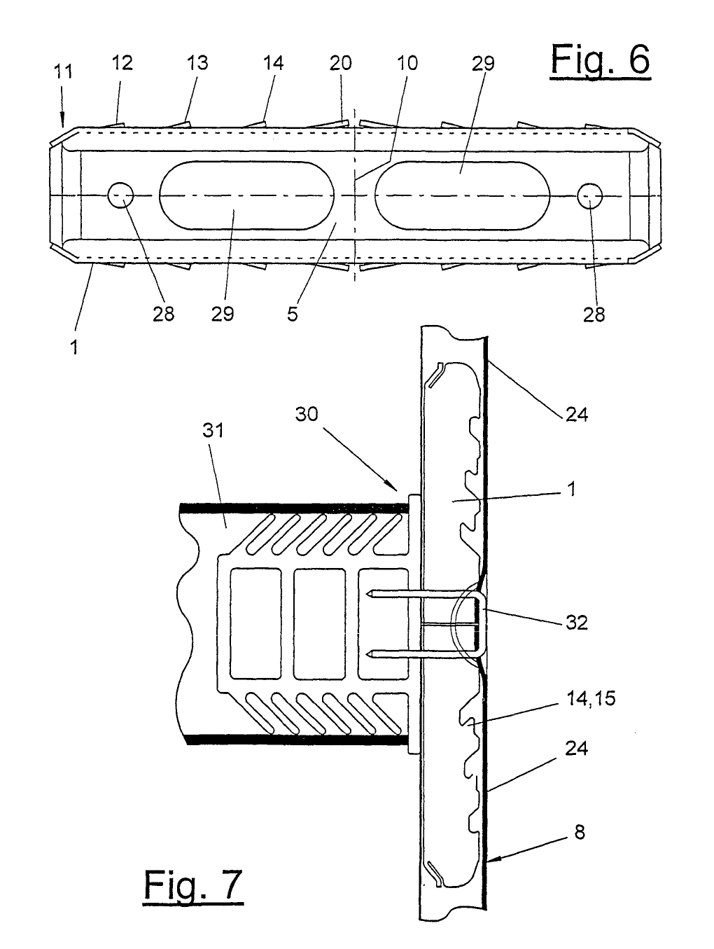

FIG. 6 shows a top view of the straight plug-in connector with additional openings on the middle wall,

FIG. 7 shows a side view of the plug-in connector in the hollow sections at a bar connection,

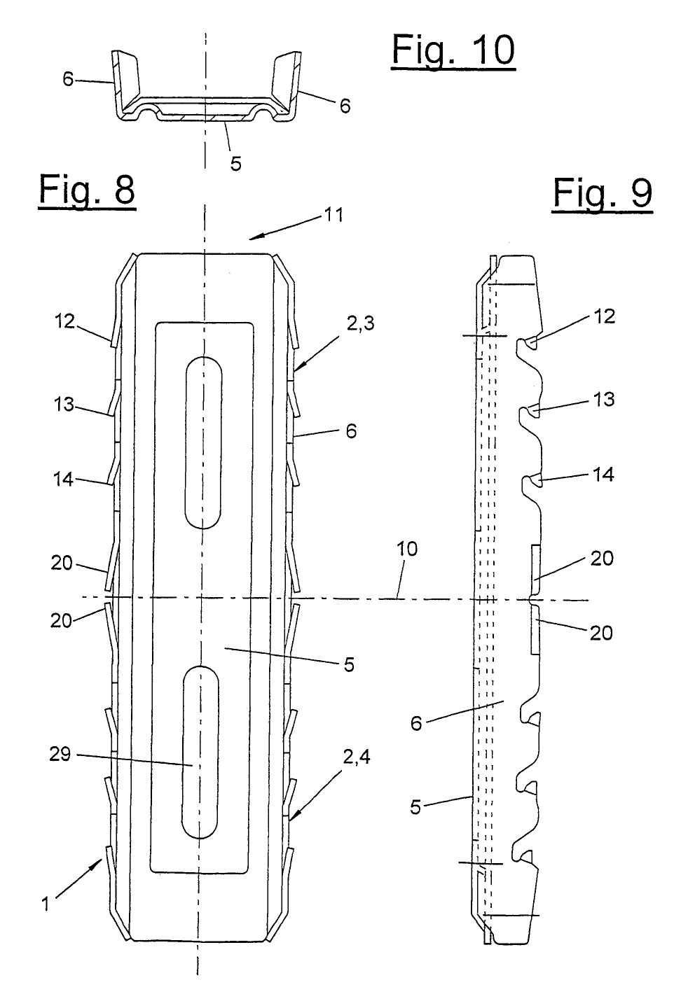

FIGS. 8 through 10 show three tilted views of a variant of the plug-in connector with other retaining elements and elastic middle stop,

FIGS. 11 through 13 show two tilted views and a cross section of another variant of the plug-in connector with other retaining elements and fixed middle stop, and

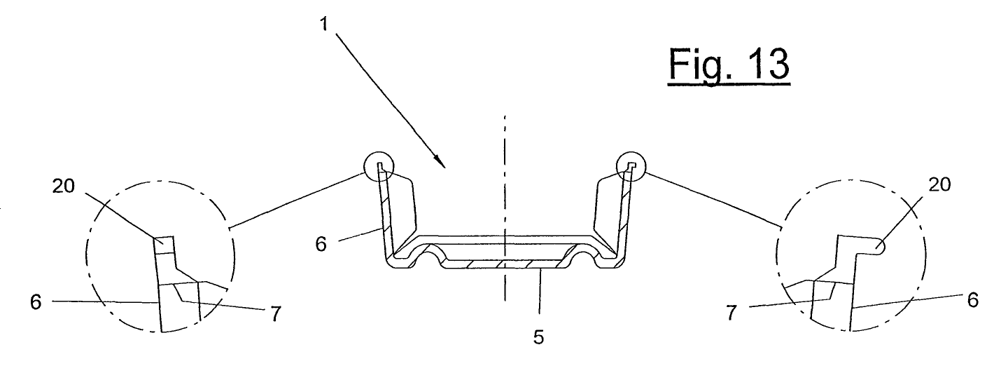

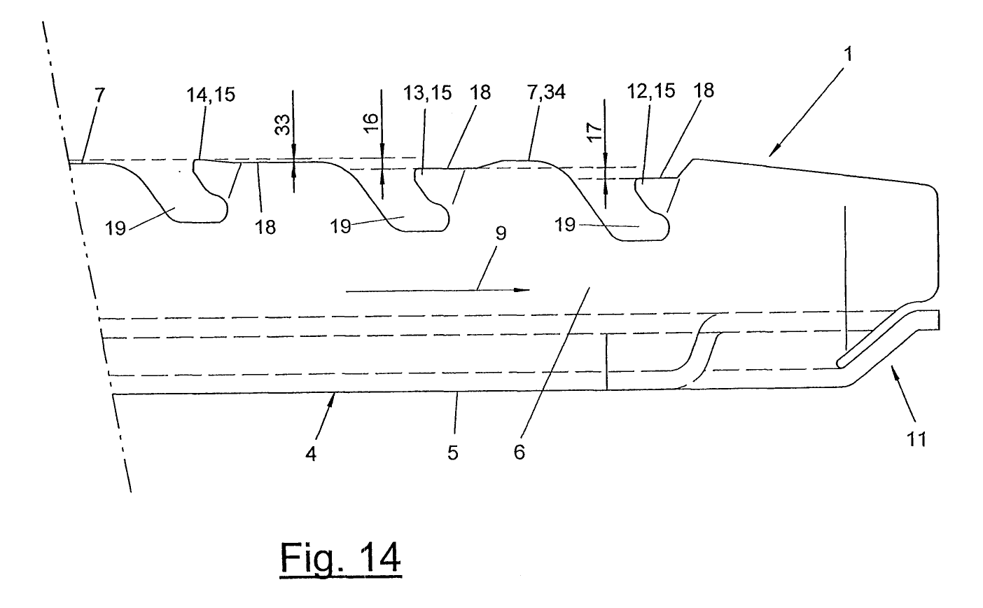

FIG. 14 shows a larger side view of the plug-in connector.

The drawings show a plug-in connector (1) for hollow sections (24). The hollow sections (24) may have any desired suitable cross section and in the preferred embodiment they are designed as hollow sections of spacer frames or as bar sections, both of which are used for insulating glass panes. A granulated desiccant (27) may be located in the hollow sections (24), as is indicated in FIG. 4. The hollow sections (24) may otherwise also have any other desired shape and another intended use. FIGS. 1, 2 and 7 show side views of one or two hollow sections (24) each. FIG. 4 shows the cross section of the hollow section (24).

In FIGS. 1 and 5 through 14, the plug-in connector (1) is designed as a straight connector for hollow sections (24) of spacer frames or for bar sections. FIG. 2 shows a modification as a corner angle for the same spacer hollow sections. In one variant, not shown, the plug-in connector (1) may also be designed as a cross connector for bar sections.

In the embodiments shown, the plug-in connector (1) has a body (2) with a usually essentially rectangular cross section adapted to the cross section of the hollow section. The plug-in connector (1) may be designed as an at least partially hollow component with a U-shaped or box-shaped cross section. It has, in particular, widely opening front sides (11) and permits the flow of the desiccant (27). As an alternative, the plug-in connector (1) may also be extensively or completely massive. The front sides (11) may be open or closed.

In the straight connector according to FIGS. 1, 5, 8 and 11, the two sections (3, 4) are flush with one another. These plug-in connectors (1) are centrally symmetrical relative to the middle (10). In the corner angle according to FIG. 2, the body sections (3, 4) are arranged at any desired suitable angle, preferably at right angles, in relation to one another.

In the case of the preferred rectangular cross-sectional shape, the plug-in connector (1) has a middle wall (5) and two side walls (6) bent at the edges of the said middle wall. The plug-in connector (1) has a U-shaped cross section in this design. In the case of a box-shaped cross section, it has a second middle wall. In the preferred embodiment as a straight plug-in connector (1) for spacer hollow sections, the plug-in connector (1) is mounted in the hollow sections (24) such that the middle wall (5) points toward the inner side of the spacer frame, while the free edges (7) of the side walls (6) are directed toward the outer side (8). This arrangement corresponds to that of the plug-in connector in EP-A 0 283 689. However, the positioning may also be reversed.

In the case of the corner angle (1) according to FIG. 2, the middle wall (5) points toward the outer side (8). The arrangement may be reversed in this case as well.

The plug-in connector (1) is always plugged into the hollow sections (24) in the direction of plugging-in (9). The sliding path is limited here by middle stops (20) at the middle (10) of the plug-in connector (1).

In the case of the straight connector according to FIGS. 1 and 8 through 10, the middle stops (20) are designed as spring bosses directed against each other, which are arranged at the edges (7) of the side walls (6) and are bent out on the side. This arrangement corresponds to EP-A 0 283 689.

In the case of the straight connector according to FIGS. 5 and 11, the middle stops (20) are designed as central fixed stops corresponding to DE-U 94 11 067 or to WO 98/05843.

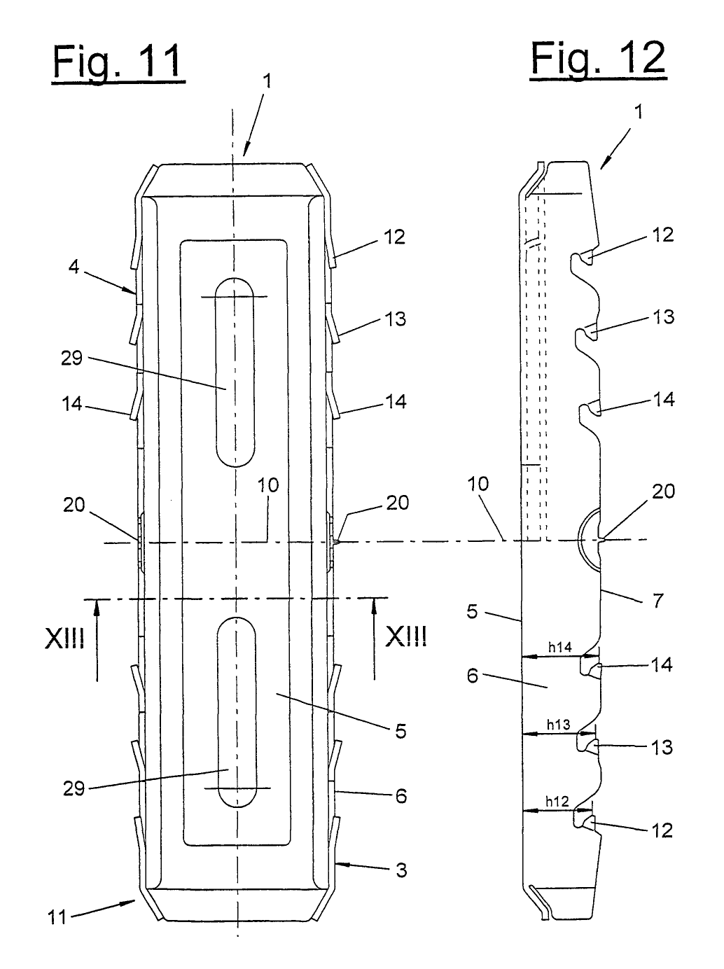

FIGS. 11 through 12 show two different embodiments for this. In one variant, which is shown in the left-hand part of FIGS. 11 and 13 as well as in the tilted side view in FIG. 12, the middle stop projects beyond the free edge (7) of the side wall (6) in the extension of the said side wall (6). In the variant shown in the right-hand halves of FIGS. 11 and 13, the middle stop (20) is bent laterally to the outside and projects laterally beyond the side wall (6).

In the case of the corner angle according to FIG. 2, the middle stops (20) are located at the corner area and the rigid wall part laterally projecting there. The middle stops (20) may otherwise also have any other desired and suitable design and may optionally also be eliminated.

The plug-in connector (1) is equipped with a plurality of retaining elements (12, 13, 14), which are to prevent the plug-in connector (1) from being pulled out of the hollow sections (24). The retaining elements (12, 13, 14) may have any desired and suitable design for this. They are preferably located at the side walls (6) and project laterally to the outside. They optionally also project upward or downward. The retaining elements (12, 13, 14) cooperate with the preferably smooth inner sides of the side walls of the hollow sections (24) and come into frictional contact with these or optionally also form a positive-locking connection.

In the preferred embodiment, the retaining elements (12, 13, 14) are designed as laterally projecting retaining bosses (15), which are in contact at their tips with the side walls of the hollow sections (24) and preferably also dig into these side walls during the plugging-in operation.

At least some of the retaining elements (12, 13, 14) of the plug-in connector (1) are arranged offset at right angles to the direction of plugging-in (9) with a mutual distance (16, 17). FIGS. 3 and 14 show this arrangement in an enlarged side view. In the case of the preferred, essentially rectangular cross-sectional shape of the plug-in connector (1), the retaining elements (12, 13, 14) assume different vertical positions h12, h13, h14 at the side walls (6). The retaining elements (12, 13, 14) arranged with an offset now act at different points on the hollow section (24). During plugging in, the retaining bosses (15) dig the tracks (21, 22, 23), which are arranged at different heights and are shown in FIGS. 1 and 2, into the side wall of the hollow section.

In the embodiments shown, the mutual offset or distance (16, 17) is present above all between the retaining elements (12, 13, 14) of every individual side wall (6) of the sections (3, 4). All retaining elements (12, 13, 14) are preferably located at a distance (16, 17) from each other, so that they all act at different points on the adjacent side wall of the particular hollow section (24).

The different side walls or side wall sections (6) may have the same arrangement of the retaining elements (12, 13, 14), because these act on different side walls of different hollow sections (24). In a variant of the embodiment shown, all retaining elements (12, 13, 14) of the plug-in connector (1) may have an offset arrangement.

In another variant, not shown, it is also possible for the distances at the different side walls to be present only partially between the retaining elements located there, and some of the retaining elements may also be arranged at the same height one after another and engage the same axial track on the corresponding hollow section side wall.

In the preferred embodiment, the plug-in connector (1) shown is manufactured as a punched and bent part from metal. It preferably consists of electrolytically galvanized or blank cold rolled steel strip. The retaining elements (12, 13, 14) are designed as punched-out and laterally bent-out retaining bosses (15), which are relatively rigid and elastically yield to lateral forces to a low extent only. Three retaining elements (12, 13, 14) each are arranged at the four different side wall sections (6) in the preferred embodiment. FIGS. 1 through 7 and 8 through 14 show two different embodiments for the arrangement of the retaining elements (12, 13, 14).

As is illustrated in FIGS. 3 and 5, the retaining element (12) located closest to the front side (11) is located at the free edge (7) of the side wall (6) in one variant. It has a distance from the middle wall (5) or a height h12. This is joined, against the direction of plugging-in (9), by a cut-out (19), which will then again rise to the normal height of the edge (7). The adjoining middle retaining element (13) is arranged lower by the distance (16) and has the smaller height h13. The edge (7) first passes over for this into a lowered axial shoulder (18), at the end of which the retaining element (13) is located. A cut-out (19) joins here as well, which will then preferably again rise to the normal edge height. The third retaining element (14), which is adjacent to the middle (10), is again arranged lower than the middle retaining element (13) by a distance (17) with the height h14. The shoulder (18) belonging to it is correspondingly set back farther from the edge (7) toward the middle wall (5). A cut-out (19) again joins here with an adjoining rise up to the normal edge height.

In the variant according to FIGS. 8 through 14, the arrangement and the vertical offset of the retaining elements (12, 13, 14) are reversed compared with the above-described arrangement. As is illustrated especially in FIGS. 12 and 14, the retaining element (14) located closest closest to the middle (10) has the greatest height h14. The retaining element (13) following it in the direction of plugging-in (9) is arranged lower by the distance (16) and has the smaller height h13. The third retaining element (12) is again arranged lower than the preceding retaining element (13) by the distance (17) and has the smallest height h12.

In the variant according to FIGS. 8 through 14, the cut-outs (19) are larger than in the first exemplary embodiment. They are L-shaped and extend behind the retaining elements (12, 13, 14) to a greater extent, and the undercut has a somewhat increasing rounding at the end. In addition, the retaining element (14), which has the greatest height h14, projects somewhat beyond the edge (7) of the side wall (6) in the embodiment according to FIGS. 8 through 14. The tip of its boss (15) extends beyond the edge (7) in the direction of extension of the side wall (6). The retaining element (14) is also bent obliquely upward toward the edge (7).

FIG. 14 shows this arrangement.

The retaining elements (12, 13) likewise have an axial shoulder (18) in this variant, and this shoulder is lowered in relation to the edge (7). While rising to the height of the edge (7), the shoulder (18) of the middle retaining element (13) may pass over into a rounding (34), which makes possible the improved sliding up and support in the hollow sections (24). The shoulder (18) of the outer retaining element (12), which shoulder is located lower, passes, by contrast, over into a sharper corner, from which the edge (7) then drops again toward the front side (11).

The retaining elements (12, 13, 14) are directed against the direction of plugging-in (9) and form a clamping digging means at the side walls of the hollow section and at the tracks (21, 22, 23) or so-called clamping paths.

The distances (16, 17) are of equal size in the embodiment shown. However, they may also be different.

The change in the vertical offset is preferably continuous, and the heights h12 through h14 increase or decrease continuously. However, the order and association of the retaining elements (12, 13, 14) of different heights shown may also vary as desired or may be, in particular, reversed or transposed. The arrangement of the retaining elements (12, 13, 14) at the other three side walls or side wall sections (6) is designed correspondingly.

In the embodiment shown, all the retaining elements (12, 13, 14) project laterally by an equal amount within the framework of the tolerance possibilities. This lateral projection may also differ in a modified embodiment. Different possibilities of deformation or bending of the hollow section side walls can be taken into account with the different amounts of projection. For example, the higher retaining elements (14) are located farther out in FIGS. 8 and 11 than the lower retaining elements (13, 12). However, the arrangement may also be reversed, as in FIG. 6. Otherwise, different lateral amounts of projection can also be used for different purposes and requirements and may have a correspondingly different design.

In another variant of the embodiment shown, the plug-in connectors (1), especially the straight connectors according to FIGS. 1, 5 and 8 through 14, may have additional retaining elements in the form of punched-out and bent-out spring bosses. This applies especially to a reversed arrangement of the plug-in connector (1) in the hollow sections (24), when the middle wall (6) also points toward the outer side. Such a plug-in connector may have, e.g., a design corresponding to EP-A 0 698 172 and have a narrow bottom plate at the middle (10) or connection point of the hollow sections (24). Otherwise, triangular recesses or recesses of another shape may also be present at the middle wall (5) for positive-locking connection with caulking at the outer wall of the hollow section.

In addition, the middle wall (5) may also have longitudinally extending deformations (26) for covering and possibly guiding at perforation lines (25) of the hollow sections (24); which perforations lines are located on the inner side.

Furthermore, the middle wall (5) may have axial and preferably oval edge openings (29) for a bar connection (30) on both sides of the middle (10) according to FIGS. 6, 7, 8 and 11. Fastening nails (32) can be shot here through the hollow sections (24) and the plug-in connector (1) into a connection plug in the front end of a bar section (31). Otherwise, fixing or centering holes (28) may also be present at the middle wall (5) in the area of the front ends (11).

In a variant of the embodiment shown, the plug-in connector (1) may also be designed as an at least extensively massive diecast part made of light metal or as a plastic part, especially as an injection molding. The retaining elements (12, 13, 14) may also be designed as laterally projecting ribs, as wedges or in another suitable manner. The retaining elements (12, 13, 14) may be extensively rigid or also elastic at least within certain limits. They may also be arranged in any other desired area of the side walls (6) and especially also in the area of the transition point to the middle wall (5). Besides the mutual distances (16, 17), the retaining elements (12, 13, 14) may also have different sizes, especially lengths or widths. In the preferred embodiment shown, the retaining bosses (15) have extensively the same shape.

### LIST OF REFERENCE NUMBERS

| | |
|---|---|
| 1 | Plug-in connector |
| 2 | Body |
| 3 | Section |
| 4 | Section |
| 5 | Middle wall |
| 6 | Side wall |
| 7 | Edge, edge area |
| 8 | Outer side |
| 9 | Direction of plugging-in |
| 10 | Middle, connection point |
| 11 | Front side |
| 12 | Retaining element |
| 13 | Retaining element |
| 14 | Retaining element |
| 15 | Retaining boss |
| 16 | Distance |
| 17 | Distance |
| 18 | Shoulder |
| 19 | Cut-out |
| 20 | Middle stop, centering stop |
| 21 | Track, clamping path |
| 22 | Track, clamping path |
| 23 | Track, clamping path |
| 24 | Hollow section |
| 25 | Perforation |
| 26 | Deformation |
| 27 | Granulated desiccant |
| 28 | Fixing hole |
| 29 | Wall opening |
| 30 | Bar connection |
| 31 | Bar section |
| 32 | Fastening nail |
| 33 | Projection |
| 34 | Rounding |
| h12 | Height of retaining element 12 |
| h13 | Height of retaining element 13 |
| h14 | Height of retaining element 14 |

1. Plug-in connector for said hollow sections (24), especially for spacer frames or bar sections of insulating glass panes, with a plurality of said lateral retaining elements (12, 13, 14), which are arranged one after another at the said side wall (6) in the said direction of plugging-in (9) of the said hollow sections (24), characterized in that at least some of the said retaining elements (12, 13, 14) are arranged offset at right angles to the said direction of plugging-in (9) with a said mutual distance (16, 17).

2. Plug-in connector in accordance with claim 1, characterized in that the said retaining elements (12, 13, 14) at the said side walls (6) assume said different height positions h12, h13, h13.

3. Plug-in connector in accordance with claim 1 or 2, characterized in that the said retaining elements (12, 13, 14) arranged offset act on the said hollow section (24) at different points.

4. Plug-in connector in accordance with claim 1, 2 or 3, characterized in that the said plug-in connector (1) has a said body (2) with a plurality of said sections (3, 4) which are flush in the said direction of plugging-in (9) or are bent, wherein the said retaining elements (12, 13, 14) located at the said side walls (6) of the said sections (3, 4) are arranged offset in relation to one another with a said distance (16, 17).

5. Plug-in connector in accordance with one of the above claims, characterized in that all said retaining elements (12, 13, 14) of the said side wall (6) of a said section (3, 4) are arranged offset with a said distance (16, 17) in relation to one another.

6. Plug-in connector in accordance with one of the above claims, characterized in that the said plug-in connector (1) has three or more said retaining elements (12, 13, 14) arranged offset at the said side walls (6) of its said sections (3, 4).

7. Plug-in connector in accordance with one of the above claims, characterized in that the said retaining elements (12, 13, 14) are designed as said retaining bosses (15) bent out laterally and acting against the said direction of plugging-in (9).

8. Plug-in connector in accordance with one of the above claims, characterized in that the said retaining elements (12, 13, 14) are arranged at the said edge area (7) of the said side wall (6), which said edge area (7) is directed toward the said outer side (8) of the said hollow sections (24).

9. Plug-in connector in accordance with one of the above claims, characterized in that the said plug-in connector (1) is designed as a punched and bent part from metal with an essentially U-shaped cross section, wherein the said offset retaining bosses (15) have said cut-outs (19) of different depths and said edge-side shoulders (18).

10. Plug-in connector in accordance with one of the above claims, characterized in that the said retaining elements (12, 13, 14) project by different amounts beyond the said side wall (6).

11. Plug-in connector in accordance with one of the above claims, characterized in that the said plug-in connector (1) is designed as a straight connector and has a said elastic or fixed middle stop (20).

12. Plug-in connector in accordance with one of the above claims, characterized in that the said plug-in connector (1) has said wall openings (29) for a said bar connection (30) at the said middle wall (5) on both sides of the said connection point (10).

13. Plug-in connector in accordance with one of the above claims, characterized in that the said plug-in connector (1) has said fixing holes (28) at the said middle wall (5) on both sides of the said connection point (10).
